(19) United States
(12) Patent Application Publication
(10) Pub. No.: US 2015/0174626 A1
(43) Pub. Date: Jun. 25, 2015

(54) PRODUCT FOR WASTE ELECTRICAL AND ELECTRONIC EQUIPMENT RE-UTILIZATION AND PROCESS THEREOF

(71) Applicant: Rahul NAGPAUL, (US)

(72) Inventor: Rahul Nagpaul, Navi Mumbai (IN)

(21) Appl. No.: 14/405,900

(22) PCT Filed: Apr. 12, 2013
(86) PCT No.: PCT/IN2013/000244

§ 371 Date: Dec. 5, 2014

(30) Foreign Application Priority Data
Jun. 13, 2012 (IN) 1714/MUM/2012

(51) Int. Cl. B09B 3/00

(52) U.S. Cl. CPC B09B 3/0025; B09B 3/0033; B09B 3/0041; B09B 2220/00

(57) ABSTRACT

A Waste Electrical and Electronic Equipment (WEEE) brick adapted to treat a bulk WEEE material for sustainable environmental reutilization is disclosed. The brick comprises a first part and a second part such that the first part is sequentially filled with a binder/filler material followed by filling with a WEEE material. The second part is securely coupled to the first part to form the WEEE brick. A process for preparation of Waste Electrical and Electronic Equipment (WEEE) brick is also disclosed.

### CROSS REFERENCE TO RELATED APPLICATION

This application is a non-provisional of, and claims priority to, Indian Patent Application No. 1714/MUM/2012, which was filed Jun. 13, 2012, and International Application No. PCT/IN2013/000244, filed on Apr. 12, 2013. The subject matter of this earlier-filed application is hereby incorporated by reference in its entirety.

### FIELD

The present invention generally pertains to bulk E-waste treatment, and more particularly, to a process for environmentally sustainable reutilization of E-waste and/or waste electrical and electronic equipment (WEEE).

### BACKGROUND

Discarded electrical and electronic devices become a prime source of waste electrical and electronics equipment (WEEE). WEEE normally contains chemical substances such as, lead, cadmium, lead oxide, silver oxide, nickel-metal hydride, brominated flame retardants, toxic gases, toxic metals, Polychlorinated Biphenyls (PCB's), acids and plastics. These chemical substances, if not treated properly, are highly dangerous and hazardous to humans, plants, and animals that greatly disturb the flora and fauna of the environment.

Various practices for E-waste disposal including, but not limited to, landfilling, incineration, soaking in open acid baths, magnetic separation and recycling are known. However, these procedures are not without pollutants, such as obnoxious gas or greenhouse gas (GHG) emissions, emission of carcinogens or teratogens and leaching of chemicals into the soil and ground water. Also, these procedures are not only unsafe, time consuming, and costly, but also require large amounts of energy consumption and special machinery or skilled workers.

Efforts are being made for recycling E-wastes for utilization in various value added applications. For example, a method for the disposal of discarded electrical and electronic equipment includes steps such as dismantling the equipment as necessary, segregating the parts into those containing glass and other items, melting the glass parts, and mixing it all together to encapsulate the waste parts in the molten glass to form pebble shaped ingots. The ingots are then used as ballast or as a building aggregate.

In addition, few efforts are seen for reutilization of WEEE in building construction. For example, a process for reuses the glass of TV and PC monitors in the manufacturing of clay bricks and roof tiles. This process includes clay grinding, mixing of clay, glass, and water, and successive storage for 7 days. The process also includes body preparation, shaping, drying, and firing through a simulation, on a laboratory pilot line, of the industrial processing of clay bricks and roof tiles.

However, these methods or processes require heat or chemical treatment of wastes to make them suitable and sustainable raw material in building construction. Also, these methods normally include extraction, re-cycling, shredding, segregation, or disposing, which are inefficient, costly, time consuming and non-environmentally friendly.

A simple, more efficient, non-polluting, environmentally friendly, expeditious process and apparatus for bulk E-waste treatment for sustainable environmental reutilization, of WEEE may be beneficial.

### SUMMARY

Certain embodiments of the present invention may be implemented and provide solutions to the problems and needs in the art that have not yet been fully solved by conventional WEEE processes. For example, a WEEE brick, and a process for preparation of the WEEE brick, may treat a bulk WEEE material for sustainable environmental reutilization.

In one embodiment, a WEEE brick includes a first part and a second part. The first part is configured to be sequentially filled with at least two layers. The second part is defined from a second piece, and includes at least two panels adapted to close the first part. Alternately, the second piece includes a single panel. The first part and second part are securely coupled to define the WEEE brick.

Preparation of a WEEE brick to treat a bulk WEEE material for sustainable environmental reutilization may include forming the first part and second part of the WEEE brick from a suitable material. The suitable materials are selected from one or more of the following: mild steel, bronze, aluminum, metal, plastic, alloys, and/or a combination thereof Alternatively, pre-fabricated panels of gravel, cement or mortar, ceramics molding, soil, clay, thermoplastic polymers, composites, fiberglass, molding sand, and/or wood may be used as, and/or in place of, the panel. WEEE material may be categorized into a small WEEE material and a large WEEE material.

A binder/filler material may be filled in a predefined proportion inside the first part of the WEEE brick. The binder material may be selected from a group comprising of epoxy resin, mortar mix, silicone sealant, reactive acrylics, and polyurethanes adhesives, reactive hot melt polyurethanes (RHMUs), cynoacrylates, polyvinyl acetates, hydrocarbon rubber based sealants, glue and cement with gravel, sand, and coarse aggregates. The categorized WEEE material may be filled in a predefined sequence and proportion inside the first part of the WEEE brick. Any precious metals and components may be extracted before inserting the WEEE material. The binder material may be allowed to settle, expand, cure, and partially harden for a predefined amount of time. The first part is securely coupled to the second part to complete the WEEE brick preparation. An outer surface of the prepared WEEE brick is corrugated with furrows or punch marks for enamel painting and rubber lamination.

Depending upon the nature or type of binder material used, each layer can be cured further after placing or embedding of WEEE and before the application of another layer with sprinkling of fresh water or by hydrating. This is done to enable the escape of any entrapped air and/or to prevent development of cracks or fissures and bubble formation.

This process may not require any chemical or physical treatment of the waste material, avoiding emission of obnoxious gas or greenhouse gas emissions. This allows the process to be environmentally friendly. The process also utilizes all E-waste and/or WEEE selected from electrical or electronic materials that are damaged, discarded, old, obsolete, and outdated in design. The process further includes wastes selected from electrical/electronic scraps, rejects from electrical/electronic manufacturing processes, historical electrical/electronic wastes, orphaned and “end of life” electrical/electronic products. The process is safe, economical, and capable of mass production on a large scale.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating a WEEE brick, according to an embodiment of the present invention.

FIG. 2A is a top view illustrating a first piece of the WEEE brick of FIG. 1 in a non-welded state, according to an embodiment of the present invention.

FIG. 2B is a top view illustrating a second piece of the WEEE brick of FIG. 1 in a non-welded state, according to an embodiment of the present invention.

FIG. 3 is a front view illustrating the first piece of FIG. 2A filled with an E-waste and a binder and/or filler material, according to an embodiment of the present invention.

FIG. 4 is a perspective view illustrating a process for transforming the first piece of FIG. 2A into a first part, according to an embodiment of the present invention.

FIG. 5 is a perspective view illustrating a process for transforming the second piece of the FIG. 2B into a second part, according to an embodiment of the present invention.

FIG. 6 is a top perspective view illustrating the first piece of FIG. 2A partially filled with the binder/filler material, according to an embodiment of the present invention.

FIG. 7 is a top perspective view illustrating a process for joining the first piece to the second piece to form the WEEE brick of FIG. 1, according to an embodiment of the present invention.

### DETAILED DESCRIPTION OF THE EMBODIMENTS

FIG. 1 illustrates a WEEE brick 10, according to an embodiment of the present invention. In this embodiment, WEEE brick 10 has a rectangular configuration defined by a plurality of flat panels adapted to be welded in a predefined form. WEEE brick 10 includes a first pair of opposed panels 12, 12′, a second pair of opposed panels 14, 14′, a top rectangular panel 16 and a bottom rectangular panel 16′. In this embodiment, panels 12, 12′, 14, 14′, 16, and 16′ are made of mild steel. In other embodiments, however, panels 12, 12′, 14, 14′, 16, and 16′ may be made from any other suitable material such as bronze, aluminum, metal, plastic, alloys, and/or a combination thereof.

It should be appreciated that panels 12, 12′, 14, 14′, 16, and 16′ may be prefabricated out of a mold in other embodiments. The mold may be made from materials including, but not limited to, gravel, cement or mortar, ceramics molding, soil, clay, thermoplastic polymers, composites, fiberglass, and/or molding sand.

In this embodiment, dimensions of WEEE brick 10 are (9″×4.5″×3″). In other embodiments, however, the dimensions of WEEE brick 10 may vary depending on the intended use of WEEE brick. WEEE brick 10 may have other shapes in other embodiments, e.g., a square shape, a conical shape, a round shape, and/or a trapezoid shape.

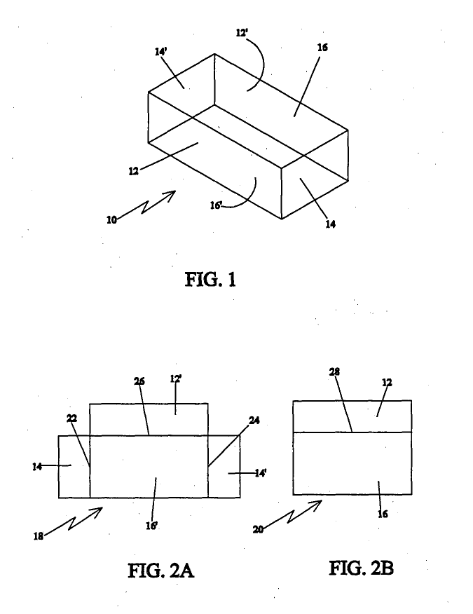

Referring to FIGS. 2A and 2B, WEEE brick 10 includes a first piece 18 and a second piece 20. First piece 18 is defined by panels 14, 14′, 12′, and 16′. Panels 14 and 16′ define a fold 22 configured to facilitate folding of panel 14 over panel 16′. Panels 14′ and 16′ define a fold 24 configured to facilitate folding of panel 14′ over panel 16′. Panels 12′ and 16′ define a fold 26 configured to facilitate folding of panel 12′ over panel 16′. Second piece 20 is defined by panels 12 and 16. Panels 12 and 16 define a fold 28 configured to facilitate folding of panel 12 over panel 16.

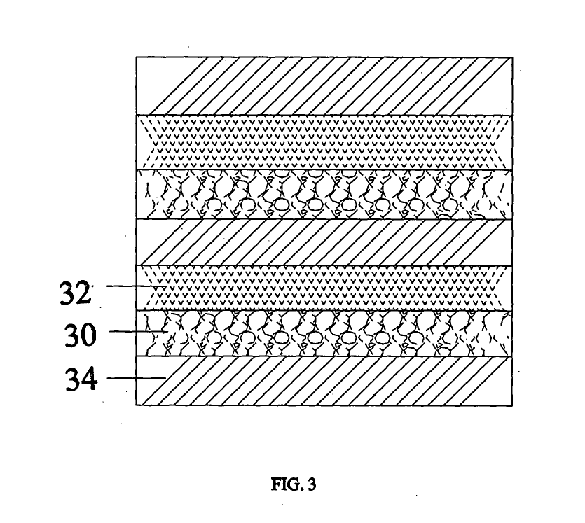

Referring to FIG. 3, a first piece 18 is filled with a large WEEE material 30 that is added over a binder/filler material layer 34. The first piece 18 is filled with a small WEEE material 32 that fills the void space between the contents of large WEEE material 30. In this embodiment, WEEE materials 30, 32 are added with binder material 34 in an approximate ratio of about 60:40. However, it should be appreciated that the ratio of WEEE material 30, 32 to binder material 34 may vary per the intended application in other embodiments of brick 10. Any precious metals and components can be extracted at this stage before inserting WEEE material 30, 32.

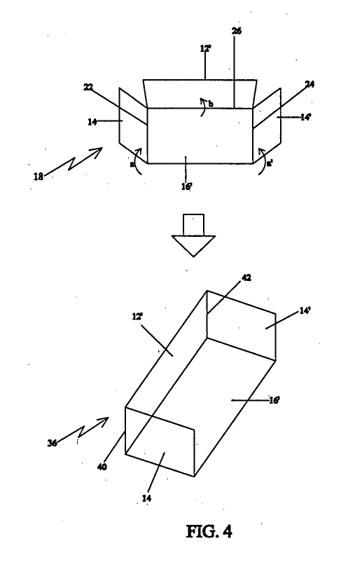

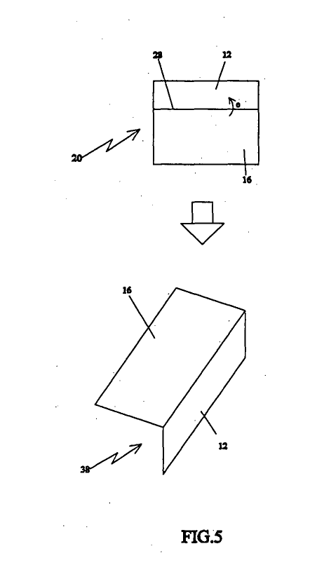

Referring to FIGS. 4 and 5, a process for the construction of WEEE brick 10 from first piece 18 and second piece 20 is described. In this embodiment, a first part 36 is formed from first piece 18 and a second part 38 is formed from second piece 20, including at least two panels 12, 16 to close first part 36. Also, in this embodiment, first and second parts 36, 38 are repetitively coated with an anti-oxide paint (primer) on the inner surfaces of first and second parts 36, 38.

First part 36 may be sequentially filled with at least two layers. The first layer may be composed of binder material 34 and the second layer may be composed of WEEE materials 30, 32 deposited on the first layer.

In a first step, panel 14 is folded at fold 22 as indicated by arrow a. Panel 14′ is folded at fold 24 with respect to bottom panel 16′ as indicated by arrow a′. Rare panel 12′ is folded at fold 26 with respect to bottom panel 16′ as indicated by arrow b. Panels 14, 14′, and 12′ are folded substantially normal to bottom panel 16′.

In next step, panel 14 is connected to panel 12′ at a first connecting edge 40. Panel 14′ is connected to panel 12′ at a second connecting edge 42. In this embodiment, edges 40, 42 are connected via a joining process such as welding. However, in other embodiments, edges 40, 42 can be connected by other suitable methods, such as arc welding, brazing, riveting, adhesive bonding, soldering, metal seaming, screw bolting, press fit, snap fit, or any other type of mechanical fastening method. In the next step, panels 12, 16 of second piece 20 are folded at fold 28, as indicated by arrow c, to form second part 38 as shown in FIG. 4.

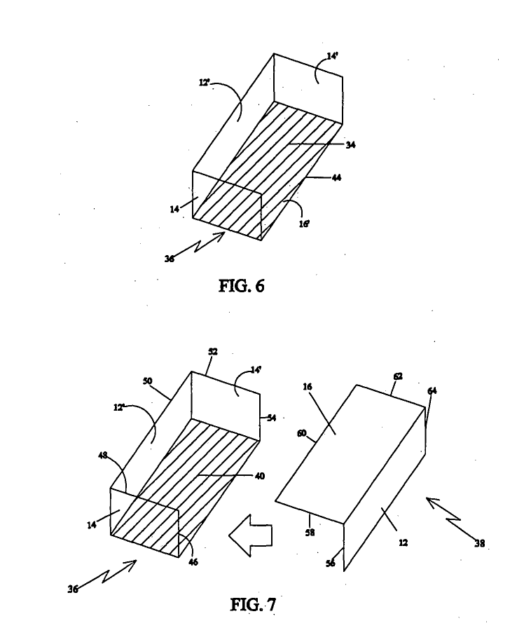

Referring to FIGS. 6 and 7, first part 36 includes an open portion 44 configured to be filled with a binder material to form a binder layer 34 that is preferably deposited on bottom panel 16′. First part 36 also includes a plurality of connecting edges 46, 48, 50, 52, and 54. Similarly, second part 38 includes a plurality of connecting edges 56, 58, 60, 62, and 64. In this embodiment, edge 46 connects to edge 56, edge 48 connects to edge 58, edge 50 connects to edge 60, edge 52 connects to edge 62, and edge 54 connects to edge 64 by welding. In other embodiments, edges 46-64 can be connected by other methods, such as arc welding, brazing, riveting, adhesive bonding, soldering, metal seaming, screw bolting, press fit, snap fit, or any other type of mechanical fastening method.

In another embodiment, WEEE brick 10 includes a first part 36 and a second part 38. First part 36 is sequentially filled with at least two layers, and second part 38, which is defined from a second piece 20, includes a single panel configured to close the first part 36. First part 36 and second part 38 are securely coupled to define WEEE brick 10.

Referring to FIGS. 1 to 7, a preferred process for bulk E-waste treatment for sustainable environmental reutilization (BEWTSER) of E-waste and/or WEEE as an alternative building material in infrastructure development and building construction or construction of any small or big structure(s) or members is discussed below. The process includes forming first part 36 and second part 38 from a suitable material, and categorizing WEEE waste material 30, 32. The process also includes filling the categorized waste in a pre-defined sequence in a predefined proportion inside first part 36, and filling first part 36 with predefined binder material 34 in a predefined proportion. The process further includes allowing binder material 34 to settle, expand, cure, and partially harden for a predefined amount of time, and closing first part 36 with second part 38 of predefined size to form WEEE brick 10. The process also includes preparing outer surfaces of WEEE brick 10 by corrugating with furrows or punch marks, coating WEEE brick 10 with a coating material, and laminating WEEE brick 10 with rubber material for aesthetics and corrosion prevention.

Also described below is a process for treating E-waste to form a WEEE brick 10, according to an embodiment of the present invention. The process may include fabricating WEEE brick 10 from mild steel panels 12, 12′, 14, 14′, 16, and 16′. Panels 12, 12′, 14, 14′, 16, and 16′ may be folded and welded together at their connecting edges to form first and second parts 36, 38. First part 36 has an open end 44 for filling with the predefined raw material, E-waste, and/or WEEE 30, 32.

The process also includes selecting all E-waste and/or WEEE 30, 32 from electrical or electronic materials that are damaged, discarded, old, obsolete, and outdated in design. WEEE 30, 32 may also be selected from electrical/electronic scraps, rejects from electrical/electronic manufacturing processes, historical electrical/electronic wastes, and/or orphaned and “end of life” electrical/electronic products. However, it is understood that batteries, except for wet batteries, e.g., lead acid and nickel metal hydride cell types, biomedical wastes, and radioactive materials or parts may be excluded from WEEE 30, 32 in this process. The E-waste may be dismantled, cut, or broken up only for size reduction purposes in some embodiments.

The process further includes filling first part 36 with binder material layer 34 followed by loose packing with E-waste and/or WEEE 30, 32. In this embodiment, WEEE 30, 32 is in a proportion of about 70 to 80 percent of the total size of first part 34, and binder material layer 34 is in a proportion of about 20 to 30 percent of the total size of first part 34. The process also includes allowing binder material layer 34 to settle, expand, cure, and partially harden for a predefined amount of time. In this embodiment, the time required for the binder material to settle, expand, cure, and partially harden is about 5 to 6 hours. However, it should be appreciated that the time required for the binder material to settle, expand, cure, and partially harden may vary depending upon the type or nature of binder material used for preparation of WEEE brick 10.

The process includes closing or sealing first part 36 and second part 38 by welding to form WEEE brick 10. Also, outer surfaces of WEEE brick 10 are corrugated with furrows or punch marks and coated with a coating material such as enamel paint and/or anti-oxidizing primer paint. However, it should be appreciated that outer surfaces of WEEE brick 10 can be uncorrugated in other embodiments of WEEE brick 10. The panels may be made of gravel, cement or mortar, ceramics molding, soil, clay, thermoplastic polymers, composites, fiberglass, molding sand, and/or wood, for example.

The process may include laminating the outer surfaces of WEEE brick 10 with a rubber coating. In other embodiments, the outer surfaces of WEEE brick 10 can be coated with other suitable agents, such as plastic enamel, a layer of Plaster of Paris (POP), cloth, fabric, leather, or any other decorative cover.

Depending upon the nature or type of binder material 34 that is used, each layer can be cured further after placing or embedding of WEEE 30, 32 and before the application of another layer with sprinkling of fresh water or by hydrating. This is done to enable the escape of any entrapped air and/or to prevent development of cracks or fissures and bubble formation. The process utilizes E-waste or WEEE 30, 32 as raw material in construction activity, for example, preparation of bricks, building material, doors, furniture, walls, road and highway blocks, etc.

The process may not require any chemical or physical treatment of the waste material, avoiding the emission of obnoxious gas or greenhouse gas emissions. As a result, the process is environment friendly. The process in some embodiments utilizes all E-waste and/or WEEE that is selected from electrical or electronic materials that are damaged, discarded, old, obsolete, and outdated in design. The process also includes wastes selected from electrical/electronic scraps, rejects from electrical/electronic manufacturing processes, historical electrical/electronic wastes, and/or orphaned and “end of life” electrical/electronic products. Larger external casings and covers of waste material may be used as empty receptacles to house the smaller WEEE pieces. The process is safe, economical, and capable of mass production on a large scale.

Some embodiments are further illustrated hereinafter by the examples discussed below.

### Example 1

In this example, WEEE brick panels 12, 12′, 14, 14′, 16, and 16′ may be prepared from a mild steel (MS) sheet. The MS sheet is procured and cut to approximately 0.8-1.2 mm and to the size 9.0+×15.0+ inches. Joints/edges 22, 24, and 26 of panels 12′, 14, 14′, and 16′ were arc welded to form a first part 36 that has a cuboid shape, with single or two panel sides in an open configuration. Panels 12 and 16 are folded at edge 28 to form second part 38. First and second parts 36, 38 are repetitively coated with an anti-oxide paint (primer) on the inner surfaces of first and second parts 36, 38. On complete drying, the first bottom layer (approximately ¼ inch in depth) of mortar 34, i.e., a mixture of cement, coarse aggregates, and water, may be applied. After about 120 to 150 minutes of setting time, larger pieces, covering or casing of WEEE 30 are inserted into the semi soft layer of mortar 34. The fresh water may be sprinkled over the semi soft layer of mortar 34 after approximately 12 hours to encourage curing and reduce chances of development of cracks or fissures.

Subsequently, the second layer of mortar 34 having a higher water content may be poured atop the first layer of mortar layer 34, ensuring that the spaces within larger pieces covering or casing of WEEE 30 are filled. After about 120 minutes, additional smaller pieces, covering, or casing of WEEE 32 are inserted into the second layer of mortar 34. The fresh water may be sprinkled after approximately 12 hours to encourage curing and reduce chances of development of cracks or fissures. This way, the process of filling mortar 34, insertion of WEEE 30, 32 and fresh water sprinkling can be repeated. The resultant mixture may be allowed to settle for 3 to 4 days. Finally, on the third or fourth day, a ¼ inch layer of Mortar 34 may be filled as an uppermost layer and allowed to cure completely. Edges 46-54 of first part 36 are then welded along the respective edges 56-64 of second part 38 to complete the WEEE Brick 10.

### Example 2

In this example, WEEE brick panels 12, 12′, 14, 14′, 16, and 16′ may be prepared from raw clay/soil. Clay may be molded using molds in brick kiln stacks by partially filling the prepared clay to ¼ inch from the side and bottom panels of the mold to form a first part 36 with an empty cuboid shaped structure. The empty cuboid shaped structure may be dried, heated, and fired and/or baked in the kiln at 600 to 1100 degrees Celsius or higher. An empty cuboid shaped structure defines an open end 44. The molded cuboid shaped structure may be filled with 70 to 80 percent WEEE material 30, 32 and 20 to 30 percent cement 34. Cement 34 may be filled in the cuboid shaped structure and leveled off In the next step, a second part 38 may be applied to complete the cuboid shape of WEEE brick 10. The formed WEEE brick 10 may be cured under a plastic sheet covering and sprinkled with fresh water after about 12 to 24 hours.

### Example 3

In this example, WEEE brick panels 12, 12′, 14, 14′, 16, and 16′ may be prepared from plastic. The sheet of plastic may be procured and cut to approximately 1.0 to 2.0 mm and to the dimensions 4.5×3.0×9.0 inches. WEEE brick 10 of the dimensions can be made in accordance with the processes described above.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that embodiments of the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A waste electrical and electronic equipment (WEEE) brick, comprising:
a first part comprising at least two layers, wherein a first layer of the at least two layers comprises one or more electrical and electronic equipment waste materials, and a second layer of the at least two layers comprises a binder material; and
a second part comprising at least two panels, wherein the second part is configured to close the first part to define the WEEE brick.

2. The WEEE brick of claim 1, wherein the first layer and the second layer are fixed with each other.

3. The WEEE brick of claim 1, wherein the first layer is configured to be deposited on the second layer.

4. A waste electrical and electronic equipment (WEEE) brick, comprising:
a first part comprising at least two layers, wherein a first layer of the at least two layers comprises one or more electrical and electronic equipment waste materials, and a second layer of the at least two layers comprises a binder material; and
a second part comprising a single panel, wherein the second part is configured to close the first part to define the WEEE brick.

5. A process for preparation of waste electrical and electronic equipment (WEEE) brick configured to treat a bulk WEEE material for sustainable environmental reutilization, the process comprising:
forming a first part and a second part of the WEEE brick from suitable material;
categorizing the WEEE material;
filling a binder and/or filler material in a predefined proportion inside the first part of the WEEE brick;
filling the categorized WEEE material in a pre-defined sequence and proportion inside the first part of the WEEE brick;
allowing the binder material to settle, expand, cure and partially harden for a predefined amount of time
closing the first part with the second part of predefined size to form the WEEE brick;
preparing outer surfaces of the WEEE brick by corrugating with furrows or punch marks;
coating the WEEE brick with a coating material; and
laminating with rubber material for aesthetics and corrosion prevention.

6. The process of claim 5, wherein the suitable material for forming the first part and the second part further comprises one or more of following: mild steel, bronze, aluminum, metal, wood, plastic, alloys, composites, clay, cement, fiberglass, ceramic, and/or a combination thereof.

7. The process of claim 5, wherein the binder material comprises epoxy resin, mortar mix, silicone sealant, reactive acrylics, polyurethanes adhesives, reactive hot melt polyurethanes (RHMUs), cynoacrylates, polyvinyl acetates, hydrocarbon rubber based sealants, glue and cement with gravel, sand, and/or coarse aggregates.

8. The process of claim 5, wherein the proportion of the binder material is approximately 20 to 40 percent of the first part of the WEEE brick.

9. The process of claim 5, wherein the time required for the binder material to settle, expand, cure and partially harden is approximately 5 to 6 hours.

10. The process of claim 5, wherein the proportion of the WEEE material is about 60 to 80 percent of the first part of the WEEE brick.

11. The process of claim 5, wherein the coating material comprises enamel paint and/or anti-oxidizing primer paint.

12. The process of claim 5, further comprising:
corrugating the brick with furrows or punch marks for enamel painting followed by rubber lamination.
